(19) United States
(12) Patent Application Publication
(10) Pub. No.: US 2024/0117844 A1
(43) Pub. Date: Apr. 11, 2024

(54) PIN COUPLING FOR CONNECTING A ROTARY DRIVE TO A PROGRESSIVE-CAVITY PUMP

(71) Applicants: Gordon L. FENTON, Beavercreek, OH (US); Christopher Oaks, Troy, OH (US)

(72) Inventors: Gordon L. FENTON, Beavercreek, OH (US); Christopher Oaks, Troy, OH (US)

(21) Appl. No.: 17/960,510

(22) Filed: Oct. 5, 2022

(51) Int. Cl. F04C 15/00; F04C 2/107; F16D 3/04; F16D 3/16

(52) U.S. Cl. CPC F04C 15/0073; F04C 2/1073; F16D 3/04; F16D 3/16; F04C 2230/603

(57) ABSTRACT

A drive having a rotary output and a pump having a rotary input are interconnected by a pin coupling that has an inner coupling head having a part-spherical outer surface and an outer coupling head having a socket. A thrust plate in the socket is formed with a part-spherical inner surface complementary to the outer surface and into which the inner coupling head is inserted with the surfaces in surface contact for transmission of axial forces. A pin extending transversely through the heads rotationally interconnects the pump input and drive output while permitting relative angular displacement of the input and output.

### FIELD OF THE INVENTION

The present invention relates to a pin coupling. More particularly this invention concerns such a coupling used between a rotary drive and a progressive-cavity pump.

### BACKGROUND OF THE INVENTION

Such a pin coupling has an inner coupling head and an outer coupling head forming a socket into which the inner coupling head is inserted. The inner coupling head and the outer coupling head are connected to one another by a coupling pin such that torque and axial force without the rotation axes of the heads being coaxial.

Preferably the outer coupling head of the pin coupling has an annular collar surrounding the socket and formed with two diametrically opposed outer holes. The inner coupling head of the pin coupling has an inner hole aligned with the outer holes of the outer coupling head. In order to connect these coupling heads the coupling pin is inserted into both the inner hole and the two outer holes. The coupling pin may be secured in its mounted position within the holes, for example by a sleeve placed on the connection. Moreover, it is possible to enclose the pin coupling with an (elastic) sealing member, for example a sealing sleeve so that the medium conveyed with the pump is prevented from contacting the pin coupling.

A progressive-cavity pump is a pump from the group of rotary positive displacement pumps used in a wide range of industrial sectors for conveying different media, and in particular liquid media, and also highly viscose liquids. The liquids to be conveyed may in this case also contain solid components.

The progressive-cavity pump comprises at least a stator, a rotor rotating in the stator, a drive for the rotor and for example a pump housing connected to the stator and that, depending on the mode of operation, is also designated as a suction housing and has at least a housing opening (for example intake) for the medium to be conveyed. The drive (for example an electric motor) operates on a centrally rotating output shaft, which may be a drive shaft or a so-called plug in shaft. The (centrally) rotating shaft is effective via a coupling device (for example a connecting rod) on the rotor or its rotor head that rotates eccentrically, this eccentricity being allowed by the coupling device/connecting rod. Thus, the shaft can be connected via a first pin coupling to the coupling device/connecting rod and the coupling device/connecting rod can be connected via a second pin coupling to the rotor or its rotor head. The rotary drive of such a progressive-cavity pump consequently comprises the shaft driven by the drive, the coupling device/connecting rod and the rotor or at least a rotor head connected to the rotor and of course the pin couplings connecting the components over an articulated movement range.

The stator of the progressive-cavity pump generally consists of an elastic material and may be enclosed or encased by a one-piece or multi-piece stator casing or stator housing, which may be made from metal or the like. The elastic (for example elastomer) stator may in this case be securely connected to the stator casing, for example vulcanized or glued. Alternatively, the stator may however also be enclosed by a stator casing in a detachable and therefore replaceable manner. Alternatively, stators made from different material, for example from metal and stators made of multiple materials, are also enclosed.

Progressive-cavity pumps of the described type are known for example from U.S. Pat. Nos. 10,161,397, 8,764,420, 8,439,659, DE 10 2018 113 347 and U.S. Pat. No. 10,326,595.

A progressive-cavity pump having pin couplings as described above is for example known from DE 101 166 41.

A modified embodiment of the pin couplings is for example described in DE 10 2006 058 166. In this case, guide bushings are inserted into the holes of the coupling heads. Another embodiment of a pin coupling for a progressive-cavity pump is disclosed in US 2015/0010342.

Generally, pin couplings have proven themselves excellent in progressive-cavity pumps for decades. However, improvements of the pin couplings will continue to be addressed. This is because the connections within the rotary drive are exposed to high axial loads during operation. Not only torques, but also high axial forces or axial loads that are created within the rotary drive have to be transmitted.

### OBJECTS OF THE INVENTION

It is therefore an object of the present invention to provide an improved pin coupling.

Another object is the provision of such an improved pin coupling that overcomes the above-given disadvantages, in particular that is particularly suited for transmitting axial force as when connected between a rotary drive and the rotor of a progressive-cavity pump.

### SUMMARY OF THE INVENTION

These objects are attained by a drive having a rotary output and a pump having a rotary input interconnected by a pin coupling that has an inner coupling head having a part-spherical outer surface and an outer coupling head having a socket. A thrust plate in the socket is formed with a part-spherical inner surface complementary to the outer surface and into which the inner coupling head is inserted with the surfaces in surface contact for transmission of axial forces. A pin extending transversely through the heads rotationally interconnects the pump input and drive output while permitting relative angular displacement of the input and output.

Thus axial forces are not or not only transmitted by the pins of the couplings inserted in the holes of the coupling heads but to significant extent by the part-spherical end of the inner coupling head interacting with the thrust plate having a matching surface.

Preferably, this thrust plate is made of a different material than the coupling heads, for example of a softer material than the inner coupling head and/or the outer coupling head. It is for example possible to use an inner coupling head and an outer coupling head made of steel, for example stainless steel, as known from the prior art. The thrust plate is for example made of a copper alloy, for example bronze that is softer than steel and self-lubricating. The part-spherical end of the inner coupling head, which is for example the part-spherical connecting rod end, exerts all axial forces through the inner coupling head (for example through the connecting rod) and into the thrust plate. The thrust plate is preferably permitted to freely rotate in operation reducing localized repetitive wear and assuring overall wear uniformity.

As already mentioned the design of the pin coupling is generally based on the known design where the outer coupling head has an annular collar surrounding the socket, the collar having two diametrically opposed outer holes and the inner coupling head has an inner hole aligned with the outer holes and the coupling pin extends through both the inner hole and the two outer holes. Preferably the pin coupling also comprises one or more (replaceable bushings in the holes of the coupling heads, for example so called outer bushings replaceably inserted into each of the outer holes of the outer coupling head, and these outer bushings each have an opening in which the coupling pin engages with its pin ends.

Preferably, according to a second aspect of the invention, the coupling pin has modified ends with non-cylindrical or non-circular cross sections. The pin coupling preferably has a cylindrical center section extending through the inner hole of the inner coupling head and at each end a non-cylindrical end of noncircular cross-section that engages in the outer hole or in the opening of the outer bushing inserted in the outer hole. This non-cylindrical end of the coupling pin is for example flattened compared to the cylindrical center. These cylindrical pins with flats at the ends allow axial displacement of the coupling center to compensate for wear of the part-spherical connecting rod and/or the thrust plate. Also the slotted bushings and cylindrical pin with flattened sides permit angular displacement of the connecting rod perpendicular to the axis of rotation permitted by the cylindrical connecting rod bushing.

Moreover the pin coupling may also comprise a so called inner bushing (replaceably) inserted into the inner hole of the inner coupling head.

The outer bushings and/or the inner bushings, preferably all of the bushings, are preferably fixed in the corresponding holes so that they cannot rotate therein. The outer bushings and/or the inner bushings, preferably all of the bushings, are for example non rotatably press fitted into the corresponding holes. The press fit is such that the bushing or the bushings cannot rotate in the hole during operation but the bearings remain generally replaceable with suitable tools for maintenance.

The pin can rotate in the inner bushing to allow angular displacement in a single plane. Moreover the flats of the pins and the openings of the outer bushings are designed and dimensioned such that the flattened ends are allowed to slide within the outer bushing creating/allowing angular motion that is perpendicular to the motion provided by the pin and the inner bushings as previously described. Since the combination of the stationary outer bushings plus rotating pin permit angular motion in one plane and the sliding of the pin with the outer bushing with flats allows angular motion in a second plane perpendicular to the previous plane, the coupling can transmit moment at any angle of the connecting rod that can be derived as a sum of the angular displacement in those two created planes.

Preferably one or more of the bushings, for example the outer bushings and/or the inner bushing, are made of a different material than the coupling heads. As already described with regard to the material of the thrust plate, the outer bushings and/or the inner bushing are for example made of a softer material than the inner coupling head and the outer coupling head, preferably of a self-lubricating material. One or more bushings are for example made of a copper alloy, for example bronze or a bronze alloy.

The novel pin coupling design is preferably used for or within a rotary drive of pump, for example a progressive-cavity pump. The rotary drive may comprise a shaft, a rotor and a connecting rod connecting the shaft and the rotor whereas the coupling connections between the shaft and the connecting rod on the one hand and the connecting rod and the rotor on the other hand are designed as the novel pin couplings according to the invention. Therefore, the shaft, which is for example driven by a drive of the pump, comprises an outer coupling head and the rotor also comprises an outer coupling head. The connecting rod comprises at both ends an inner coupling head so that the first inner coupling head of the connecting rod is inserted into the outer coupling head of the shaft and the second inner coupling head of the connecting rod is inserted into the outer coupling head of the rotor.

In conclusion, the novel coupling design is a specially designed tandem coupling that is designed to transfer axial thrust and moment while permitting one of the ends to move freely within a plane where angular displacement is defined for example to be less than 4° and the spacing between drive and driven machine is held constant. The geometry of the coupling separates the sum of the force vectors into moments transferred and axial thrust resistance into the minimum coupling diameter through optimization of forces over the largest load-bearing areas of the coupling. This results in a coupling that maximizes moment transfer and axial thrust resistance into a minimum volumetric coupling displacement.

The novel construction is optimized in order to separate axial forces and torque, i.e. to separate the regions that are involved in the different types of force transmission. In particular, the load acting on the pins is reduced which often where weak points in the state of the art.

The new design allows for a reduction of the size of the coupling components with the same force transmission so that machines, e.g. pumps, are available with the same power and smaller design.

The coupling design can utilize self-lubricating, grease and/or oil as a means of reducing frictional forces and/or heat of the components in operation based on the intended duty cycle and magnitudes of the forces expected in the chosen application. The novel coupling design eliminates the need to have a hobbed part-spherical gear or a standard cylindrical pin coupling to transfer radial moment as previous designs utilized by designers in the art. The design eliminates the gear (from previous art) by optimizing the surface area, moment arm length and angle of transmitted force with cylindrical pins machined preferably with flats perpendicular to forces located in peak loading areas. The bushings used with the cylindrical pins with flattened force transfer surfaces are restrained to rotate through operation while sliding axially permitting maximum angular deflection of the drive shaft during operation.

As described, the part-spherical connecting rod ends interact with matching thrust plates preferably manufactured of a softer, self-lubricating material. part-spherical connecting rod end exerts all axial forces through the connecting rod and into the thrust plate. The thrust plate is permitted to freely rotate in operation reducing localized repetitive wear and assuring overall wear uniformity. The cylindrical pins with flats allow for axial displacement of coupling center to compensate for wear of the part-spherical connecting rod and/or thrust plate.

In a preferred embodiment the novel pin coupling design is used for our used within a progressive-cavity pump having a drive, a stator and a rotary drive, the rotary drive preferably comprising at least a shaft, a connecting rod and the rotor rotating within the stator whereas the shaft is connected to the connecting rod with a first pin coupling and the connecting rod is connected to the rotor with a second pin coupling. One of these pin couplings or preferably both of these pin couplings are designed as described.

### BRIEF DESCRIPTION OF THE DRAWING

The above and other objects, features, and advantages will become more readily apparent from the following description, reference being made to the accompanying drawing in which:

FIG. 1 is a largely axial section through a progressive-cavity pump, drive coupling, and rotary drive according to the invention;

FIG. 2 is a perspective view of the drive coupling;

FIG. 3A is a side view of the coupling;

FIG. 3B is an axial section through the coupling;

FIG. 3C is a cross section through the coupling; and

FIG. 4 is a large-section view of a detail of FIG. 3B.

### SPECIFIC DESCRIPTION OF THE INVENTION

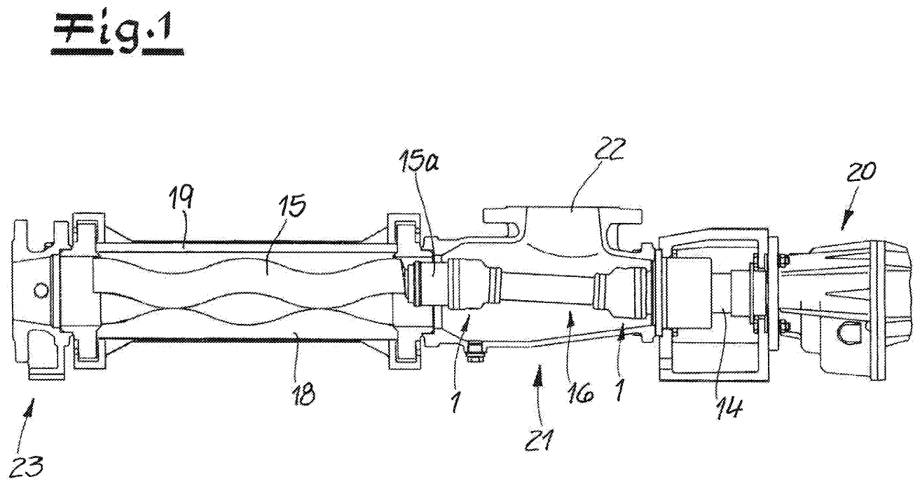

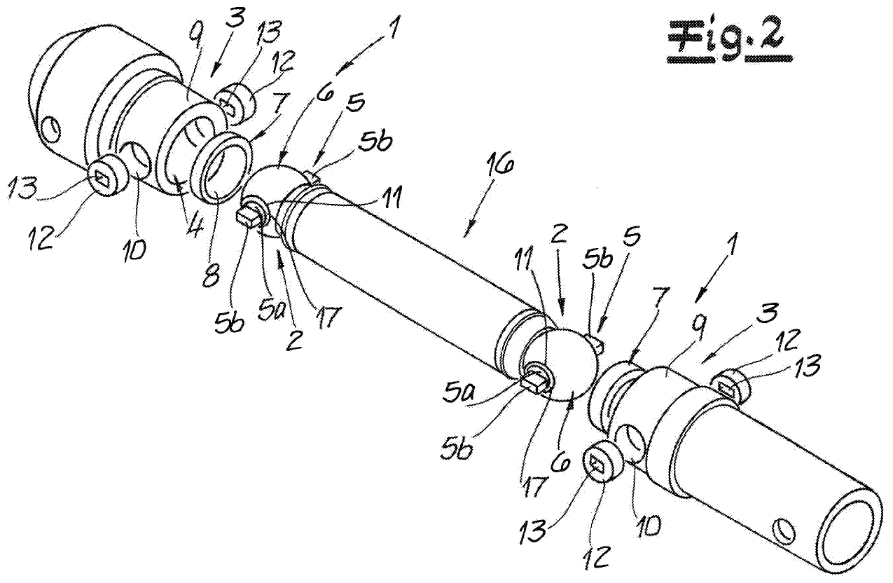

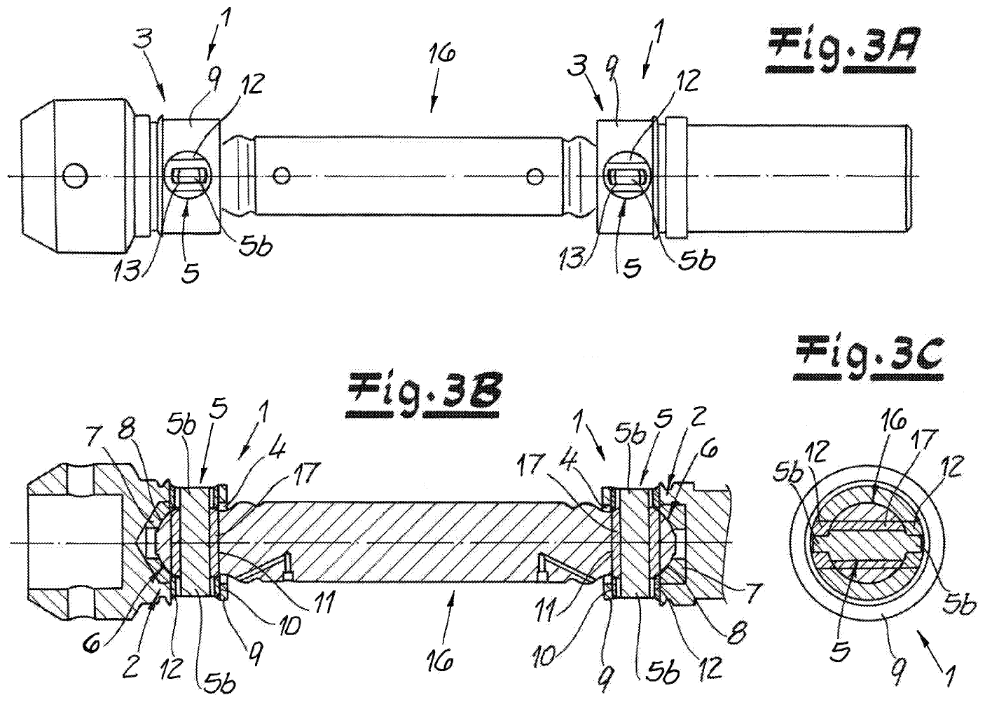

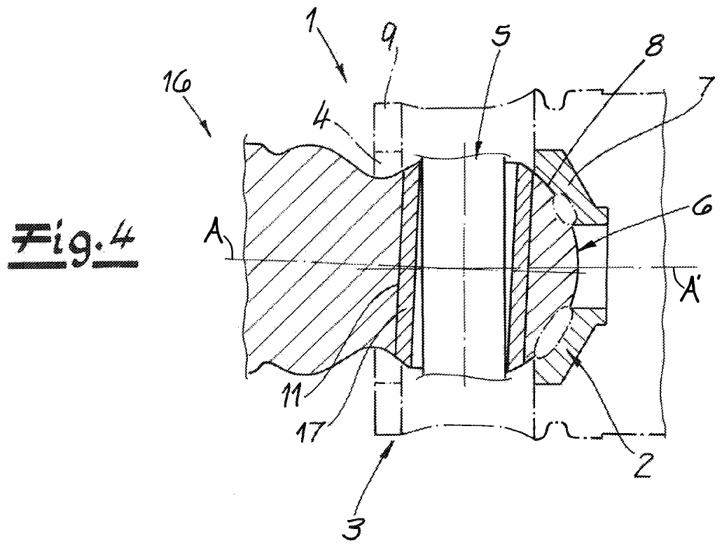

As seen in FIG. 1 a progressive-cavity pump has a stator 18, a rotor 15 rotating in the stator 18 and a drive 20 for the rotor 15. The progressive-cavity pump can have a central pump or suction housing 21. In this case, the pump housing 21 is connected to the stator 18 on the suction side. On the opposite side of the pump housing, for example a further housing part 23 is connected to the stator 18 and serves an input or pressure connection. The pump housing 21 has an opening 22 used for example as intake for the medium to be conveyed, so that depending on the direction of operation the medium is conveyed for example from the pump housing 21 through the stator 18 to the pressure connection 23. The drive 20 rotates a shaft 14 constructed for example as a drive shaft or a plugin shaft. The centrally rotating shaft 14 applies torque to a connecting rod 16 on the rotor 15 such that the rotor and the rotor head rotate eccentrically with an eccentricity that is ensured by the connecting rod 16 that connects the shaft 14 with the rotor 15 by pin couplings 1. Thus, the shaft 14 is connected via a pin coupling 1 to the connecting rod 16 and then via a second pin coupling 1 to the rotor 15 or its rotor head 15a. The rotary drive of this progressive-cavity pump consequently comprises the shaft 14 driven by the drive, the connecting rod 16 and the rotor and, of course, the two pin couplings 1 connecting these components for rotation about respective axes. The connecting rod 16 is centered on an axis A that, as shown in FIG. 4, is not always coaxial to the axis A′ about which the shaft 14 rotates.

The stator 18 is made of an elastic material and is enclosed or encased by a stator housing 19 only shown schematically. Each of the two shown pin couplings 1 comprises an inner coupling head 2 and an outer coupling head 3 whereas the outer coupling head 3 has a socket 4 into which the inner coupling head 2 of the respective pin coupling 1 is inserted. The inner coupling head 2 and the outer coupling head 3 are connected to one another by a respective coupling pin 5 such that torque and axial force can be transmitted permitting angular displacement. The outer coupling head 3 has an annular collar 9 surrounding the socket 4, the collar 9 having two diametrically opposed outer holes 10. The inner coupling head 2 has an inner hole 11 aligned with the outer holes. The coupling pin 5 extends through both the inner hole 11 and the outer holes 10 and connects the respective two coupling heads 2, 3.

Moreover, the drawing shows that each pin coupling 1 also comprises an inner bushing 17 in the inner hole 11 and outer bushings 12 in the outer holes 10. Each outer bushing 12 has as described in more detail below an opening 13 into which the respective coupling pin 5 engages with its ends.

According to a first aspect of the invention the pin coupling 1 also comprises a thrust plate 7. Therefore, the inner coupling head 2 has an end with a part-spherical outer surface 6 and is inserted into the socket 4 of the outer coupling head 3 with the interposition of the thrust plate 7, and the inner coupling head 2 contacts a complementary part-spherical inner contact surface 8 of the thrust plate 7 with its part-spherical outer contact surface 6.

According to a second aspect of the invention the coupling pin 5 is modified and has a cylindrical center 5a in the inner hole 11 or the bushing 17 inserted in this inner hole 11. Moreover, the coupling pin 5 has non-cylindrical ends 5b of noncircular cross-section. The non-cylindrical ends 5b engage into the outer hole 10 or into the opening 13 of the respective bushing 12 in the respective outer hole 10. As shown in the figures, the non-cylindrical ends 5b of the coupling pins 5 and the openings 13 are flattened compared to the cylindrical center 5a.

The inner bushing 17 is fixed in the hole 11 so that it cannot rotate in the hole 11. The outer bushings 12 are also fixed in the respective outer holes 10 so that they cannot rotate therein. However, the pin 5 can rotate in the bushing 17 and this allows angular displacement in a first plane. Moreover, the flattened ends 5b of the pin 5 on the one hand and the opening 13 of the bushing 12 are designed and dimensioned such that the flat ends 5b of the pin 5 can to slide linearly in the respective bushings 12, thereby creating/allowing angular motion that is perpendicular to the motion provided by the pin 5 and the bushing as described above. In the shown embodiment this is realized in that the flattened ends 5b of the pins have a smaller width than the openings 13. Since the combination of the stationary bushing 17 plus rotating pin 5 permits angular motion in a first plane and sliding of the pin 5 within the bushing 12 with openings 13 allows angular motion in a second plane perpendicular to the first plane, the coupling can transmit moment at any angle of the connecting rod 16 that can be derived as a sum of the angular displacement in those two planes.

The thrust plate 7 and the bushings 12, 17 are made of a different material than the inner coupling head 2 and the outer coupling head 3, in particular of a softer material which is for example a self-lubricating material.

With regard to the first pin coupling 1 connecting the drive shaft 14 and the connecting rod 16, the outer coupling head is part of the drive shaft 14 and the inner coupling head 2 is part of the connecting rod 16.

With regard to the second pin coupling 1 connecting the connecting rod 16 and the rotor 15, the inner coupling head 2 is part of the connecting rod and the outer coupling head 3 is part of the rotor 15 or its rotor head 15a.

In a preferred embodiment the drive shaft 14, the connecting rod 16 and/or the rotor 15 or its rotor head 15a are made of steel which means that the inner coupling heads 2 and the outer coupling heads 3 of the pin couplings are made of alloyed steel.

The thrust plate 7 and/or the outer bushings 12 and/or the inner bushing 17 are for example made of a copper alloy, for example bronze or a bronze alloy. The thrust plate 7 can rotate freely in operation, thereby reducing localized repetitive wear and assuring overall wear uniformity. The cylindrical pins 15 with flat ends 5b allow axial displacement of coupling center to compensate for wear of the part-spherical connecting rod 16 and/or the thrust plate 7. Also, the design permits angular deflection of the connecting rod in the plane perpendicular to the access of the inner coupling bushing 17.

We claim:

1. In combination with a drive having a rotary output and a pump having a rotary input, a pin coupling comprising:
an inner coupling head having a part-spherical outer surface;
an outer coupling head having a socket;
a thrust plate in the socket and formed with a part-spherical inner surface complementary to the outer surface and into which the inner coupling head is inserted with the surfaces in surface contact; and
a pin extending transversely through the heads and rotationally interconnecting the pump input and drive output while permitting relative angular displacement of the input and output.

2. The combination according to claim 1, wherein the outer coupling head has an annular collar surrounding the socket and having two diametrically opposed outer holes, the inner coupling head has an inner hole aligned with the outer holes, and the coupling pin extends through both the inner hole and the two outer holes.

3. The combination according to claim 2, further comprising:
a respective replaceable bushing in each of the outer holes, the bushings each having an opening in which the coupling pin engages with its pin ends, the bushings being fixed against rotation in the holes.

4. The combination according to claim 3, wherein the coupling pin has a cylindrical center extending through the inner hole and at each end a non-cylindrical end with a non-circular cross-section engaging in the respective outer hole.

5. The combination according to claim 4, wherein the non-cylindrical ends of the coupling pins are flattened compared to the respective cylindrical centers.

6. The combination according to claim 1, further comprising:
a bushing fixed in the inner hole against rotation.

7. The combination according to claim 1, wherein the thrust plate is of a different material than the inner coupling head and/or the outer coupling head.

8. The combination according to claim 1, wherein the thrust plate is made of a softer material than the inner coupling head and/or the outer coupling head.

9. The combination according to claim 7, wherein the inner coupling head or the outer coupling head is made of steel and the thrust plate is made of a copper alloy or a copper alloy.

10. The combination according to claim 4, wherein the flattened ends of the coupling pin are inserted into the outer holes of the outer coupling head such that the respective bushings are oriented perpendicular to a plane formed as center line of the bushings rotated about the axis of rotation of the outer coupling.

11. In combination:
a rotary drive having an output shaft rotatable about a drive-shaft axis and having an end;
a progressive-cavity pump offset axially from the drive and having a rotor with axially spaced from the drive output shaft;
an axially extending connecting rod having an inner rod end juxtaposed with the drive shaft and an outer rod end juxtaposed with the rotor end; and
respective inner and outer pin couplings between inner and outer ends of the connecting rod and the drive shaft and rotor end, each pin coupling comprising:
an outer socket on the outer end of the respective rod end and formed with a part-spherical surface, whereby axial force is transmitted between the rod and the socket at the part-cylindrical surfaces,
a part-cylindrical surface on the respective rod end fitted complementarily into the respective outer surface of the respective socket, and
a pin extending transversely through the respective socket and the respective rod end and angularly coupling the connecting rod to the respective socket.
